(19) United States
(12) Patent Application Publication
(10) Pub. No.: US 2007/0051159 A1
(43) Pub. Date: Mar. 8, 2007

(54) Way of preventing critical phenomena in ceramic electrodes of magnetic hydrodynamic power generators

(76) Inventor: Aleksandr Brodsky, New York, NY (US)

Correspondence Address: Aleksandr Brodsky, Apt. 3W, 118 St. Mark's Place, New York, NY, 10009, US

(21) Appl. No.: 11/211,216

(22) Filed: Aug. 24, 2005

(51) Int. Cl. G01L 25/00

(52) U.S. Cl. 73/1.11; 315/111.81

(57) ABSTRACT

This invention is a method of determining parameters of safe functionality of different dynamical systems, including ceramic electrodes of magnetic hydrodynamic power generators, described by nonlinear partial differential equations enabling engineering of such systems so that catastrophic movement of the system from one state to another will be impossible.

### CROSS FERERENCE TO RELATED APPLICATIONS

1. Provisional Patent Application 60/604,136 (filed Aug. 23, 2004)

2. U.S. patent application Ser. No. 11/211,216 (filed Aug. 24, 2005)

3. Provisional Patent Application 60/711,147 (filed Aug. 24, 2005)

### STATEMENT REGARDING FEDERALLY SPONSORED RESERCH

Not applicable.

### NAMES OF THE PARTIES TO A JOINT RESEARCH APPLICATION

Not applicable.

### REFERENCE TO A SEQUENCE LISTING

Not applicable.

### BACKGROUND OF THE INVENTION

The subject invention has to do with methods of controlling (by provoking or preventing) critical phenomena in nonlinear devices constituting catastrophic transition from one state to another due to the existence of multiple solutions to the corresponding mathematical models. For instance, high-temperature electrodes utilized as current collectors in the channel of magnetohydrodynamic (“MHD”) power generators appear to be an example of such devices where nonlinear effects are responsible for thermal breakdown of such devices.

In magnetohydrodynamic power generators, Joule heat is utilized to produce high-velocity streams of electrically conductive fluid (or plasma) that stream through a magnetic field in order to convert the kinetic energy of the stream into electrical energy. Basic “window frame” MHD power generators are comprised of elongated ducts or channels consisting of open rectangular “window frames” that are insulated from each other and cooled by a liquid passing through coolant channels surrounding each frame, which are situated side by side. The electrodes used for collecting the electrical current produced in the channel by the streaming of high-temperature conductive fluids through the magnetic field are generally rectangular and are attached to the inner perimeter of each frame, typically by brazing. Even if divergent generator geometries are used, in each case, the electrodes are present mounted end to end on each frame, separated by an electrical insulation, as some electrodes act as anodes and some as cathodes as the plasma passes through the channel perpendicular to the longitudinal axis of the electrodes.

The environmental conditions within a given channel in which the electrodes must function are very severe, and strenuous physical demands are placed on them. The plasma, which may be either an ionized gas or an inert gas seeded with a conductor such as potassium, may reach temperatures of up to 2800° C. while the surface of the electrode may reach about 2000° C. However, since the window frames to which the electrodes are attached are generally made of copper, the electrode-frame temperatures can be no more than about 600°-1000° C. Thus, the electrodes must be capable of withstanding a temperature differential between electrode-plasma interface and the electrode-frame interface of up to about 1400° C. Minimizing the temperature differential within the plasma between the plasma core and the electrode-plasma interface increases the energy conversion efficiency. The electrode must be able to withstand erosive forces since as the plasma passes through the duct it may approach or even exceed sonic velocity. The electrode must either be protected from oxidation or be prepared of oxidation-resistant materials, since many plasmas, depending upon the particular fluid and its source, are slightly oxidizing at operating temperatures. The electrode must also be able to withstand the effects of potassium at operating temperatures when it is present as seed material in the fluid. The electrode must be constructed of materials which are electrically conductive at the normal operating temperature of the electrode, which usually requires that the electrode be constructed of several different materials because of the temperature differential through the electrode. Finally, since there is always the possibility of generator malfunction, the electrodes must be able to withstand the thermal shock of sudden heating or cooling without the electrode separating from the channel or without the upper high-temperature erosion-resistant layers spalling from the remainder of the electrode. Thus, it is a problem to find a material or materials and an electrode design from which electrodes can be made that can withstand the rigors of such an environment.

The use of cold electrodes in the electrode wall of magnetohydrodynamic generators results in the low temperature of plasma in contact with the electrode, thus causing a boundary layer in the flow so that the current can go through this layer only in a contracted way (arcs) due to thermal or electrical breakdown instability in the said boundary layer. These arcs appear to be damaging to the electrodes, making magnetohydrodynamic generators dysfunctional. One of the possible ways to decrease the damaging effects of said arcs on magnetohydrodynamic generator electrodes is by making them of ceramic materials (e.g., magnesium oxide, aluminum oxide or magnesia-alumina-spinel), so that the temperature of the plasma or fluid in immediate contact with these electrodes is relatively high.

Unfortunately, electric current passing through ceramic electrodes can contract, causing a high temperature area inside them caused by Joule heating. The reason for this is thr dependency of coefficients of electrical and thermal conductivity so that the corresponding equation of thermal conductivity with Joule heating becomes substantially nonlinear. The possibility of several solutions to such nonlinear equations of thermal conductivity is responsible for the contraction of the current and the corresponding damage to the electrodes. Determining the conditions and design of ceramic electrodes to prevent the transition of temperature distribution inside them from expanded to contracted form can prevent critical heat breakdown.

### BRIEF SUMMARY OF THE INVENTION

The invention has to do with the design of different devices (for instance, ceramic electrodes of MHD power generators or energy generators utilizing transformation of energy of rest mass of gas of particles into radiation) utilizing methods of controlling (by preventing or provoking) critical phenomena relating to transformation from one solution to another of the corresponding nonlinear mathematical models.

### BRIEF DESCRIPTION OF THE SEVERAL VIEWS OF THE DRAWING

FIGS. 1-15: See (I) Detailed Description of the Invention

FIG. 16. Clockwise from top left (gray area represents ceramics; black area represents metal)
View 1: Electrode from the front
View 2: Electrode from the left
View 3: Electrode from the top

FIG. 17: Power generation utilizing transformation of the rest mass of bose condensate into radiation.

### DETAILED DESCRIPTION OF THE INVENTION

Mathematical description of critical phenomena in different devices was considered. It appeared that this critical phenonema, constituting catastrophic transition from one solution of corresponding mathematical model to another, can be controlled by varying boundary conditions so that this critical phenomena can either be provoked or made impossible.

For instance, a ceramic electrode has been developed that addresses the problem of thermal breakdown within the body of the electrode, which is caused by Joule heating. To accomplish this, the following non-linear boundary value problem corresponding to thermal conductivity with Joule heating was considered:
λ(T)ΔT(x)+σ(T)(∇Ψ)²=0,on G T(x)=T₀ for x=g₁ ∇T(x)=B₁ for x=g₂
∇(σ(T)∇Ψ)=0,on G Ψ(x)=0 for x=g₁ ∇T(x)=B₂ for x=g₂
g₁+g₂=∂G xεG (1)

, where T(x)—temperature, ΨT(x)—electrical potential, λ(T)—coefficient of thermal conductivity, σ(T)—coefficient of electrical conductivity, G—area of consideration, g₁—contact surface between the ceramic body of the electrode and the metal frame of the electrode, g₂—contact surface between the ceramic body of the electrode and gas (plasma) flow.

It is obvious that the key element of the design of the electrode is a configuration of ceramic and metal parts producing a corresponding boundary value problem that will have only one solution, so that the catastrophic transition from an expanded low temperature solution to a contracted high temperature solution will be impossible. But finding the bifurcation points and determining branches of solutions for nonlinear boundary value problems of partial differential equations appears to be one of the most difficult problems of modern mathematics. [1,2,7,8] In order to overcome this difficulty, the following method of alternative parameters is presented.

Method of Alternative Parameters

Perturbation theory cannot be applied in the neighborhood of a given bifurcation point and numerical methods require that the branches of solutions be chosen before these methods can be applied [7].

In section 1, the method of alternative parameters is introduced and applied to analytically solve a 1-dimensional nonlinear boundary value problem in order to establish basic concepts of the method and apply it to an n-dimensional case.

In section 2, the method of alternative parameters is discussed relative to n-dimensional nonlinear boundary value problems. It is applied both to the 1-dimensional case in order to compare results with the analytical solution, and to the 2-dimensional case in order to demonstrate its ability to calculate the bifurcation solution in a many-dimensional case.

In section 3, the method of alternative parameters is applied to quantum field theory equations (a double well potential equation and the Gross-Pitaevskii equation) in order to demonstrate that bifurcation is possible in these models. It appears that the application of these methods is crucial to obtaining results of quantum field theory equations. Analytical solutions obtained by the method of alternative parameters demonstrate that it is necessary to take into account the global structure of space-time in order to state the boundary conditions for nonlinear quantum field theory equations.

Basic Concepts of the Method of Alternative Parameters

Consider the following 1-dimensional boundary value problem on segment [−1; 1] as an approximate model of problem (1)

$$\begin{matrix}\frac{{ⅆ}^{2}}{ⅆ {x}^{2}} u ( x ) = - D θ ( u ) , & u ( - 1 ) = u ( 1 ) = 0 , & D > 0 , \\ u ( - 1 ) = u ( 1 ) = 0 , & D > 0 , & \end{matrix} \qquad ( 2 )$$

where D is a free parameter and θ(u)=e^{u}. A point D=D_{b} exists so that system (2) reaches a point of bifurcation, and for D<D_{b}, it has two solutions. To prove it, let's consider an alternative problem:

$$\begin{matrix}\frac{{ⅆ}^{2}}{ⅆ {x}^{2}} u ( x ) = - D θ ( u ) , & u ( - 1 ) = u ( 1 ) = 0 , & u ( 0 ) = r , \\ u ( - 1 ) = u ( 1 ) = 0 , & u ( 0 ) = r , & {u}^{′} ( 0 ) = r , \\ u ( 0 ) = r , & {u}^{′} ( 0 ) = 0 , & u ( 1 ) = r ,\end{matrix} \qquad ( 3 )$$

Here r is a free parameter and D(r) is a function of r. Using the well-known substitution of y=u′(x), x=x(u), system (3) can be solved analytically and the solution can be presented as follows:

$$1 - x ( u ) = {\int }_{0}^{u} \frac{ⅆ η}{\sqrt{2 D {\int }_{η}^{r} θ ( ξ ) ⅆ ξ}} . \qquad ( 4 )$$

Substituting boundary condition u(1)=0 in (3) yields:

$$\begin{matrix}\sqrt{D ( r )} = {\int }_{0}^{r} \frac{ⅆ η}{\sqrt{2 {\int }_{η}^{r} θ ( ξ ) ⅆ ξ}} \\ = {\int }_{0}^{r} \frac{ⅆ η}{\sqrt{2 ( {ⅇ}^{r} - {ⅇ}^{η} )}} \\ = \sqrt{2} {ⅇ}^{\frac{r}{2}} ln ( \sqrt{{ⅇ}^{r} - 1} + {ⅇ}^{\frac{r}{2}} ) .\end{matrix} \qquad ( 5 )$$

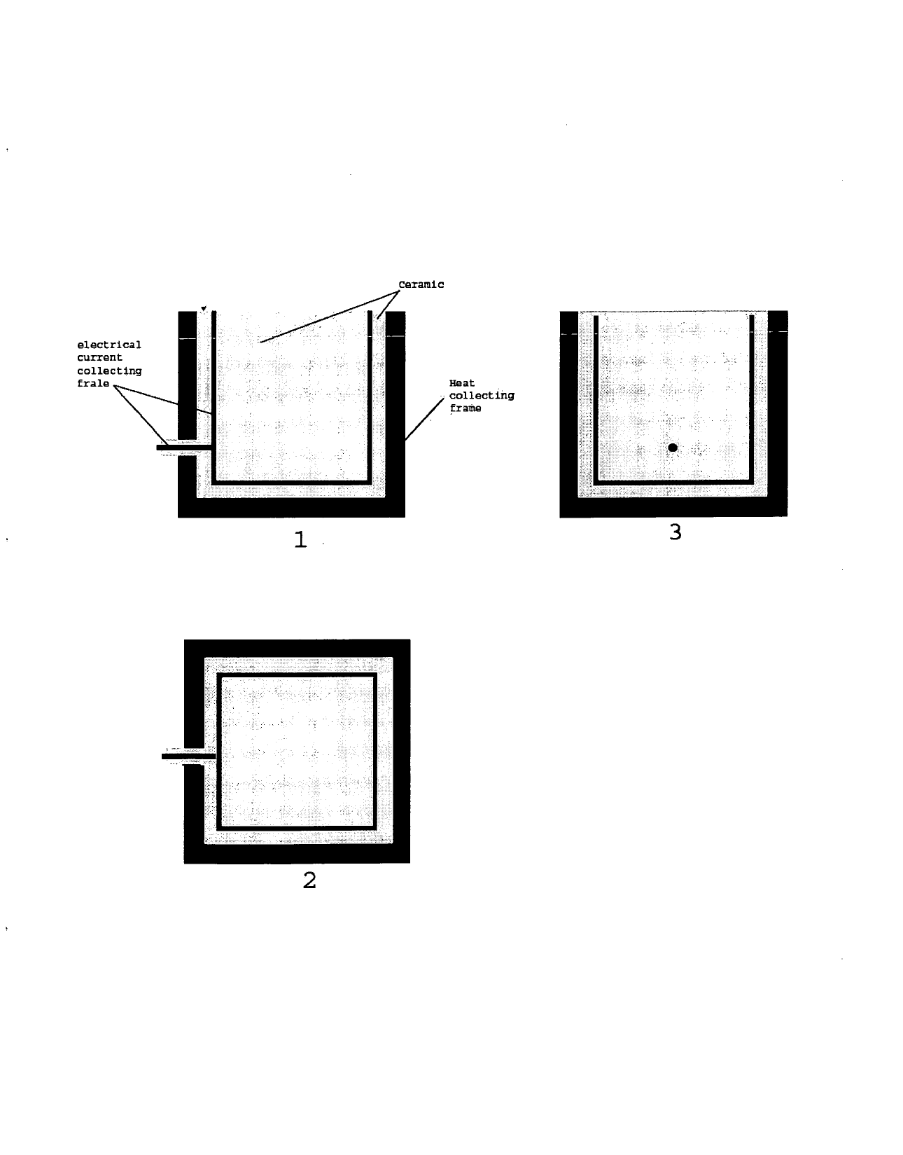

This can be simplified to
D(r)=2e^{-r}(a tan \sqrt{1−e^{-r}})². (5′)
The plot of function D(r) is presented on FIG. 1.

[image]

For D=D(r_{b}),r_{b}=1.1875 system (1) goes through a point of bifurcation for and its solution is unique. It is easy to see that for D<D(r_{b}), system (1) has two solutions, while the solution to (2) remains unique for any r. So, restating boundary value problem (1) as an alternative boundary value problem (2) enables us to calculate and present both branches of solutions in a unified manner.

Method of Alternative Parameters in the n-Dimensional Space

Solving problem (1) in the I-dimensional case, we were able to introduce the alternative parameter u(0)=r successfully because we knew a priori (due to the symmetry of the problem) that x=0 was the maximum point of function u(x). For the n-dimensional case, in which n>1, this approach cannot be used. But it is natural to assume that some kind of functional, F(u(x)), xεRⁿ, can be used as an alternative parameter. The choice of this functional may vary depending on the specifics of the problem. In order to establish an adequate alternative parameter r, let's consider the following nonlinear boundary value problem on domain GεRⁿ:
Δu(x)=−Dθ(u(x)) on G,
u(x)=0, xε∂G, (6)
where θ(u)>0 is analytical, D>0 and ∂G is a closed, smooth boundary of domain G. Boundary value problem (6) has, in general, many solutions. Hypothetically speaking, in order to parameterize these solutions one must make D depend on alternative parameter r:
Δu(x)=−D(r)θ(u(x)) on G,
u(x)=0, xδ∂G. (7)
System (7) is equivalent and an alternative to system (6), and in that sense r is an alternative parameter to D. Our goal is to choose parameter r so that every solution to boundary value problem (6) corresponds to a point on plane D−r, so that the set of all solutions to system (7) can be presented as a curve on this plane (e.g., FIG. 2). This goal can be achieved by introducing the following alternative parameter r, defined as

$$\begin{matrix}r = {\int }_{G} f ( u ) ⅆ x , \\ where & ( {7}^{′} ) \\ f ( u ) = {\int }_{0}^{u} θ ( ξ ) ⅆ ξ & ( {7}^{″} )\end{matrix}$$

The solution u(x) to boundary value problem (6) is bifurcating if and only if λ=0 is an eigenvalue of the following linear boundary value:

$$Δ v ( x ) + D ( τ ) {θ}^{′} ( u ) v ( x ) = λ v ( x ) on G , \\ v ( x ) = 0 x ∈ \partial G , \\ where \\ {θ}^{′} ( u ) = \frac{ⅆ θ ( u )}{ⅆ u} . \qquad ( 8 )$$

There exists [3] some neighborhood of the bifurcation point so that solutions to problem (6) can be parameterized by some parameter τ, and the solutions are differentiable with respect to this parameter. Without losing generality, we can set τ=0 at the point of bifurcation. Differentiating equation (6) with respect to τ, we obtain:

$$Δ w ( x ) + D ( 0 ) {θ}^{′} ( u ) w ( x ) + \frac{ⅆ D}{ⅆ τ} θ ( u ) = 0 , \qquad ( 9 )$$

where we set

$$w ( x ) = \frac{\partial u ( x )}{\partial τ} .$$

Multiplying both sides of (9) by u(x) and w(x) and integrating over G, we obtain the following equations:

$$\begin{matrix}D ( 0 ) {\int }_{G} ( θ ( u ) - {θ}^{′} ( u ) u ) w ⅆ x = \frac{ⅆ D ( 0 )}{ⅆ τ} {\int }_{G} θ ( u ) u ⅆ x \\ and & ( 10 ) \\ \frac{ⅆ D ( 0 )}{ⅆ τ} \frac{ⅆ r ( 0 )}{ⅆ τ} = {\int }_{G} {( ∇ w )}^{2} ⅆ x - D ( 0 ) {\int }_{G} θ ( u ) w ⅆ x , & ( 11 )\end{matrix}$$

respectively. Normalizing v by ∫_{G}v²dx=1, multiplying equation (8) by v, and integrating over G, we obtain the following:

$$λ = \frac{{\int }_{G} [ {( ∇ v )}^{2} - D ( τ ) {θ}^{′} ( u ) ] ⅆ x}{{\int }_{G} {v}^{2} ⅆ x} = \frac{ⅆ D ( τ )}{ⅆ τ} \frac{ⅆ r ( τ )}{ⅆ τ} . \qquad ( 12 )$$

Let's consider how the eigenvalues of perturbation problem (8) change while parameter r is increasing. For r=0, the solution to boundary value problem (7) is trivial and equal to zero. There exists a neighborhood of r=0, so that r and D are sufficiently small and all eigenvalues of (8) are positive. These eigenvalues generally decrease while r is increasing, and at point r=r_{b}, the first eigenvalue of (8)−λ₁(r)−hits zero, causing bifurcation to occur. The corresponding first eigenfunction of (8), w(x,r_{b})=v₁(x), cannot be negative, therefore,

$$\frac{ⅆ r}{ⅆ τ} = \frac{ⅆ}{ⅆ τ} {\int }_{G} f ( u ) ⅆ x = {\int }_{G} θ ( u ) \frac{\partial u}{\partial τ} ⅆ x = {\int }_{G} θ ( u ) {v}_{1} ⅆ x > 0. \qquad ( {12}^{′} )$$

But from (12) and (13) it follows that r can be used as an alternative parameter to define the solution in some neighborhood of the first bifurcation point of problem (6).

Analyzing equation (11) we conclude that parameters D(τ) and r(τ) cannot attain extremum simultaneously, because if they were to attain extremum simultaneously at τ₀, the right hand side of equation (11) is of the second order in (τ−τ₀), while the left hand side of (11) is proportional to λ(τ) and therefore is of the first order in τ−τ₀, as τ→τ₀. Indeed, it is obvious that if λ(τ) is proportional to the second order in (τ−τ₀), then (τ=τ₀) is not the point of bifurcation. That allows us to introduce the length of curve τ on plane D-r (FIG. 2), defined by the formula
dτ=\sqrt{dD²+dr²} (13)
as the ultimate alternative parameter to system (6), and use it not only for the first bifurcation, but for all the other bifurcations as well.

Let's consider the possibility of a second bifurcation. There exists some neighborhood of the point of bifurcation D=D_{b}, τ=τ₀, so that w(x)=v(x)+O((τ−τ_{b})²). After the first bifurcation all eigenvalues except the first one are positive. A second bifurcation in perturbation problem (8) can occur only in two cases:

Case 1: the first eigenvalue increases and hits zero. In Case 1, just before the second bifurcation, the first eigenvalue λ₁(r) is negative. Correspondingly, the right hand side of equation (11) is negative, while dD(τ)/dτ is negative also. Hence, dr(τ)/dτ is positive.

Case 2: the second eigenvalue decreases and hits zero. In Case 2, just before the second bifurcation, the second eigenvalue λ₂(r) is positive. Correspondingly, the right hand side of equation (11) is positive, while dD(τ)/dτ is negative. Hence, dr(τ)/dτ is negative and parameter r attains extremum between the first and second bifurcations.I

In Case 1, just after the second bifurcation, all eigenvalues of problem (8) are positive. If the first eigenvalue hits zero again and the third bifurcation occurs, then parameter r is increasing and possibly does not attain extremum between the second and third bifurcations and can be used as an alternative parameter for the third bifurcation. By induction, if the solution to problem (7-7′) is unique, it is characteristic for all bifurcations in problem (6) that the first eigenvalue hits zero. These conclusions are qualitatively demonstrated on FIGS. 2 and 3.

[image]

If the properties of problem (6) correspond to the plot presented on FIG. 2, the method of alternative parameters defined by equations (7-7′) can be used to solve n-dimensional boundary value problem (6). (The conditions for the actualization of the situation corresponding to the plot on FIG. 3 are not discussed in this article.)

The solution u(x) is obtained as Taylor series:

$$u ( x ) = r {\sum }_{k = 0}^{∞} {u}_{k} ( x ) {r}^{k} , \\ D ( r ) = r {\sum }_{k = 0}^{∞} {D}_{k} {r}^{k} . \qquad ( 14 )$$

And furthermore,

$$θ ( u ) = {\sum }_{k = 0}^{∞} {{θ}_{k} ( r {\sum }_{m = 0}^{∞} {u}_{m} ( x ) {r}^{m} )}^{k} , \\ f ( u ) = {\sum }_{k = 1}^{∞} {{θ}_{k - 1} ( r {\sum }_{m = 0}^{∞} {u}_{m} ( x ) {r}^{m} )}^{k} . \qquad ( {14}^{′} )$$

It is clear that in problem (7-7′) one can use as an alternative parameter any analytical, monotonically increasing function p(r) instead of alternative parameter r to satisfy the equation. This function can be explicitly given as Taylor series:

$$p ( r ) = {\sum }_{k = 0}^{∞} {p}_{k} {r}^{k} \qquad ( {14}^{″} )$$

The choice of this function does not influence the outcome of the calculations, but it can accelerate convergence of the Taylor series of u(x) presented by (14). The calculation of the Taylor coefficients can proceed as follows: one may substitute (14) and (14″) into (7) and compare the coefficients at the same powers of r. The results are:
1. Terms of the Taylor series containing r:

$$Δ {u}_{0} ( x ) = - {d}_{0} {θ}_{0} , \\ {u}_{0} ( x ) = - {d}_{0} {θ}_{0} {\int }_{G} Γ ( x , y ) ⅆ y , \\ {\int }_{G} θ ( 0 ) {u}_{0} ⅆ x = {p}_{1} , \qquad ( 15 )$$

which implies

$${d}_{0} = - \frac{{p}_{1}}{{θ}_{0} {\int }_{G} {\int }_{G} Γ ( x , y ) ⅆ y ⅆ y} . \qquad ( {15}^{′} )$$

2. Terms of the Taylor series containing r²:

$${r}^{2} Δ {u}_{1} ( x ) = - ( {d}_{0} r + {d}_{1} {r}^{2} ) ( {θ}_{0} + {{θ}_{1} ( {u}_{0} r + {u}_{1} {r}^{2} )}^{2} ) , \\ {u}_{1} ( x ) = - {\int }_{G} ( {d}_{0} {θ}_{1} {u}_{0} + {d}_{1} {θ}_{0} ) Γ ( x , y ) ⅆ y , \\ {\int }_{G} ( θ ( 0 ) {u}_{1} + \frac{1}{2} {θ}_{1} {u}_{0}^{2} ) ⅆ x = {p}_{2} = 0 , \qquad ( 16 )$$

which implies

$${d}_{1} = - \frac{{\int }_{G} [ \frac{1}{2} {θ}_{1} {u}_{0}^{2} + {θ}_{0} {\int }_{G} {d}_{0} {θ}_{1} {u}_{0} Γ ( x , y ) ⅆ y ] ⅆ x - {p}_{2}}{{θ}_{0}^{2} {\int }_{G} {\int }_{G} Γ ( x , y ) ⅆ y ⅆ x} . \qquad ( {16}^{′} )$$

The Green function r(x,y), defined by the boundary value problem
ΔₓΓ(x,y)=δ(y) on G,
Γ(x)=0 xε∂G (17)
was used in previous calculations.

This procedure can be continued until the necessary precision is obtained. The analytical expression of the coefficients is possible if Γ(x) is given as an analytical expression. It is worth mentioning that this procedure is non-perturbational, as it does not require any additional condition, such as r<<1.

In order to demonstrate this procedure we apply it to 1-dimensional problem (1). The following strategy was used: the first two terms of the Taylor series u(x,r) were calculated with p(r)=r, and then the function

$$p ( r ) = exp ( \frac{2}{3} r + \frac{8}{45} {r}^{2} ) \qquad ( 18 )$$

was constructed, so that conditions

$$\frac{ⅆ D ( 0 )}{ⅆ r} = 1 and \frac{{ⅆ}^{2} D ( 0 )}{ⅆ {r}^{2}} = 0 \qquad ( {18}^{′} )$$

are satisfied. The choice of p(r) does not affect the results, but fewer members of Taylor series (14-14′) are required to obtain the necessary precision. The result of these calculations is the following:

$$D ( r ) = r - \frac{104}{525} {r}^{3} - \frac{1058}{23625} {r}^{4} + \frac{43171}{1684375} {r}^{5} + \frac{23893132}{1773646875} {r}^{6} + O ( {r}^{7} ) . \qquad ( {18}^{″} )$$

On FIG. 4 both this result and analytical solution (4) are compared. The difference between the calculations of D(r) using the first 9 terms of the Taylor series and analytical solution (5) appears to be less than 0.047%. It is interesting to note that functions uₙ(x) are exact analytical expressions for the terms of Taylor series (14). In this sense solutions (18″) appear to be analytical solutions of problem (2) also. The same holds for the n-dimensional case as soon as the analytical expression of Green function G(x) (17′) is available.

[image]

r_{b}=1.1875, p(r_{b})=2.556, D(r_{b})=0.8746, p₂(r_{b})=2.556, D₂(r_{b})=0.8784

1—D₁(r)—results of the calculation of parameter D, using formula (4); p₁(r)—was calculated by substituting formula (3) into (7)

2—D₂(r)—results of the calculation of parameter D, using formulas (15-16′); p₂(r) for the second curve was calculated using formula (18).

The method of alternative parameters can be used to solve problem (7) using standard mathematical software (MathCAD, Mathematica, Mathlab, etc.). The following boundary value problem was solved to demonstrate potential applications of the method of alternative parameters presented above:

$$G = ( 0 ; 1 ) \times ( 0 ; 1 ) , \\ \frac{{ⅆ}^{2}}{ⅆ {x}^{2}} u + \frac{{ⅆ}^{2}}{ⅆ {y}^{2}} u = - D ( r ) {ⅇ}^{u} , \\ \begin{matrix}u = 0 & x ∈ \partial G ,\end{matrix} \qquad ( 19 )$$

where r is implicitly defined by equation

$$p ( r ) = {\int }_{0}^{1} {\int }_{0}^{1} ( {ⅇ}^{u} - 1 ) ⅆ x ⅆ y \qquad ( {19}^{′} )$$

while p(r) is constructed using procedure (18-18′):
p(r)=0.2415352(exp(0.145387r)−1). (19″)
Let's consider functions gₖ(x,y) and wₖ(x,y), implicitly defined by equations:

$$\begin{matrix}D ( r ) θ ( u ) = r {\sum }_{k = 0}^{∞} {D}_{k} {r}^{k} {\sum }_{k = 0}^{∞} {{θ}_{k} ( r {\sum }_{m = 0}^{∞} {u}_{m} ( x ) {r}^{m} )}^{k} \\ = {\sum }_{k = 0}^{∞} ( {g}_{k} + {D}_{k} {θ}_{k} ) {r}^{k} . \\ f ( u ) = {\sum }_{k = 1}^{∞} {{θ}_{k - 1} ( r {\sum }_{m = 0}^{∞} {u}_{m} ( x ) {r}^{m} )}^{k} \\ = {\sum }_{k = 0}^{∞} ( {u}_{k} + {w}_{k} ) {r}^{k} ,\end{matrix} \qquad ( 20 )$$

where k is an index of the corresponding member of the Taylor series. Substituting gₖ and wₖ into (14-17) and taking advantage of the fact that gₖ and wₖ do not depend on uₖ and Dₖ, one can obtain the following recurrent formula:

$${D}_{k} = - \frac{{p}_{k} - {θ}_{0} {\int }_{G}^{} ( {v}_{k} ( x ) + {w}_{k} ( x ) ) ⅆ x}{{θ}_{0}^{2} {\int }_{G}^{} I ( x ) ⅆ x} , \qquad ( 21 )$$

where vₖ(X) solves the following linear boundary value problems:
Δvₖ(x)=gₖ(x) on G,
v(x)=0, xδ∂G. (23)
and I(x) solves the following linear boundary value problems:
ΔI(x)=1 on G,
I(x)=0, xε∂G, (24)

The calculations for the solutions to linear boundary value problems (23-24), vₖ(x) and I(x), were performed using the standard function multigrid(u,n) in MathCad. The calculations of the solution to nonlinear problem (19) were performed using the first eight terms of the Taylor series and the values of D(r) were calculated based on them. The results of these calculations are presented on Figures. (5,6).

[image]

The analysis of the calculations shows that the method of alternative parameters can be successfully applied to numericall as well as analyticall solve many-dimensional nonlinear boundary value problem (2). Representation of the solution to (2) as Taylor series (14) can be useful not only for actual calculation of the solution to (2) in the neighborhood of the bifurcation point, but also to determine the global structure of the solution set and its asymptotical behavior. Actualization of this program requires calculation of the absolute value of the remainder of the Taylor series, which can be achieved by implementing standard methods but will not be presented here.

Applications to Solving Nonlinear Equations of Quantum Field Theory

Non-perturbational methods of solving nonlinear partial differential equations are very important for engineering, but these methods are absolutely crucial to quantum field theory. Indeed, applications of perturbation theory usually produce singularities, while the method of alternative parameters sometimes allows us to avoid them in order to solve equations of quantum field theory. To demonstrate, let's consider the following quantum field system of dimension 1+1, defined by action integral:

$$S = {\int }_{{t}_{1}}^{{t}_{2}} {\int }_{G}^{} ( \frac{1}{2} {( \frac{\partial ϕ}{\partial t} )}^{2} - \frac{1}{2} {( \frac{\partial ϕ}{\partial x} )}^{2} - U ( ϕ ) ) ⅆ x ⅆ t , \\ with potential U ( ϕ , a , b , c ) = ( \frac{a}{2} {ϕ}^{2} + \frac{b}{4} {ϕ}^{4} + \frac{c}{6} {ϕ}^{6} ) , \qquad ( 25 )$$

where φ(x,t) is a scalar field function and a, b, c are constant. The following motion equation,

$$\frac{{\partial }^{2} ϕ}{\partial {t}^{2}} - \frac{{\partial }^{2} ϕ}{\partial {x}^{2}} = - \frac{\partial }{\partial ϕ} U ( ϕ ) = - ( a ϕ + b {ϕ}^{3} + c {ϕ}^{5} ) ,$$

is determined by action integral (25). Static φ(x) satisfies the following nonlinear differential equation:

$$\frac{{ⅆ}^{2} ϕ}{ⅆ {x}^{2}} = a ϕ + b {ϕ}^{3} + c {ϕ}^{5} . \qquad ( 26 )$$

The plots of U(φ, a, b, c) for different values of a, b, c are presented on FIG. 7.

[image]

[image]

Plot 1 on FIG. 7 represents potential U(φ, a, b, c), where a=−μ²=−1, b=λ=0.8, c=0. The following Lagrangian corresponds to this potential:

$$L ( ϕ ) = {\int }_{G}^{} ( \frac{1}{2} {( \frac{\partial ϕ}{\partial t} )}^{2} - \frac{1}{2} {( \frac{\partial ϕ}{\partial x} )}^{2} + \frac{{μ}^{2}}{2} {ϕ}^{2} - \frac{λ}{4} {ϕ}^{4} ) ⅆ x . \qquad ( 27 )$$

This Lagrangian defines the standard model of quantum field theory that is used to demonstrate the restoration of the symmetry broken due to the “tunnel” effect [4,5]. This model is used because of two important features: even ground state (since the problem is symmetrical), and the existence of two local minimums in the potential function at

$$ϕ = \pm \frac{μ}{\sqrt{λ}} .$$

It is important that the “classical” motion equation

$$\frac{{ⅆ}^{2} ϕ}{ⅆ {x}^{2}} = - {μ}^{2} ϕ + λ {ϕ}^{3} , \qquad ( 28 )$$

which is derived from the Lagrangian (27), is usually [4,6] subjected to the following boundary conditions at infinity:

$$\frac{ⅆ}{ⅆ x} ϕ ( - ∞ ) = \frac{ⅆ}{ⅆ x} ϕ ( ∞ ) = 0 \qquad ( {28}^{′} )$$

The non-trivial solution of this boundary value problem is

$$ϕ ( x ) = \frac{μ}{\sqrt{λ}} tanh ( \frac{μ}{\sqrt{2}} x ) \qquad ( {28}^{″} )$$

But boundary conditions defined at infinity exclude from consideration trajectories corresponding to multiple passes from one extremum to another, as these trajectories can be considered only if the distance between the points of extremum of U(φ) is finite. In addition, the topology of the Friedman cosmological model demands periodic boundary conditions. So it is reasonable to model the Universe by the scalar field, defined on a circle, so that field equations (28-28′) become subject to the following periodic boundary conditions:

$$ϕ ( - L ) = ϕ ( L ) , \\ \frac{ⅆ}{ⅆ x} ϕ ( - L ) = \frac{ⅆ}{ⅆ x} ϕ ( L ) , \\ L = \frac{π}{m} R , \\ m = 1 , 2 , … , \qquad ( 29 )$$

where R is the radius of the “Universe,” and m is the number of “kinks” in the solution. For simplicity, the value of m will be considered in this paper to be equal to 1.

The solutions to (26) depend substantially on the coefficients a, b, c. For instance, the potential U₂(φ)=U(φ, 0, −μ², λ) (FIG. 7, curve 2) has the same properties as the potential U₁(φ)=U(φ,−μ²,−λ,0) (FIG. 7, curve 1), which corresponds to the standard model, while at the same time its solutions are substantially different from solution (28″). The potential U₃(φ)=U(φ,−η,−μ²,λ) (FIG. 7, curve 3) can be used to construct field theory with two topological sectors, one of which corresponds to the trajectory passing from the left minimum to the central minimum, while the other corresponds to the trajectory passing from the right minimum to the central minimum [4].

Let's consider motion equation (26) subjected to periodic boundary conditions (29). Without loss of generality we can move the origin to the point where U(φ) has the maximum.
It follows that φ(x) is an even function of x. Hence, boundary conditions (29) imply:

$$\frac{ⅆ}{ⅆ x} ϕ ( - L ) = \frac{ⅆ}{ⅆ x} ϕ ( L ) = \frac{ⅆ}{ⅆ x} ϕ ( 0 ) = 0. \qquad ( 30 )$$

Later we will use r=φ(0) as an alternative parameter in the same manner as in (2).

Let's consider equation (26) with U=U₁:

$$\frac{1}{2} \frac{ⅆ}{ⅆ ϕ} {υ}^{2} = - {μ}^{2} ϕ + {λϕ}^{3} , \qquad ( 31 )$$

where

$$v = \frac{ⅆ}{ⅆ x} ϕ .$$

Hence,

$$\frac{ⅆ}{ⅆ ϕ} {υ}^{2} = - {μ}^{2} {ϕ}^{2} + \frac{λ}{2} {ϕ}^{4} .$$

Integrating this over [−L; L] and substituting w=arcsin (φ/r) and

$$χ = \frac{μ}{\sqrt{2}} x ,$$

we obtain

$$χ ( β ) = {\int }_{arcsin \frac{ϕ}{r}}^{\frac{π}{2}} \frac{ⅆ w}{\sqrt{2 - β ( 1 + {sin}^{2} w )}} . \qquad ( 32 )$$

Combining (32) with the boundary conditions (30), we conclude that ν(±r)=0, which implies:

$$ω ( β ) = {\int }_{- \frac{π}{2}}^{\frac{π}{2}} \frac{ⅆ w}{\sqrt{2 - β ( 1 + {sin}^{2} w )}} , \\ where \\ ω ( β ) = \frac{L μ}{\sqrt{2}} , \\ β = \frac{λ {r}^{2}}{{μ}^{2}} . \qquad ( 33 )$$

Since the expression under the square root in (33) should be non-negative, it follows that 0<β<1. The plot of function ω(β) is presented on FIG. 8.

[image]

In order to obtain (28″), we move the origin of the coordinate system in (32) to some point x, so that φ(x)=0 and β→1. Solutions (32,33) can be interpreted as final distance trajectories or “classical” trajectories corresponding to the system multiple passing from one potential well to another. Certain publications [5,6] point out that such trajectories can contribute substantially to action integral (25).

As mentioned above, one can develop quantum field theory based on potential U₂(φ) for the same reasons as for potential U₁. The corresponding motion equation is

$$\frac{{ⅆ}^{2} ϕ}{ⅆ {x}^{2}} = \frac{1}{2} \frac{ⅆ}{ⅆ ϕ} {υ}^{2} = - {μ}^{2} {ϕ}^{3} + {λϕ}^{5} . \qquad ( 34 )$$

Applying procedures (31-33) to equation (34) with boundary conditions (29) yields,

$$\begin{matrix}χ ( \tilde{ϕ} , β ) = {\int }_{arcsin \tilde{ϕ}}^{\frac{π}{2}} \frac{ⅆ w}{\sqrt{β ( 1 + {sin}^{2} ( w ) - β ( 1 + {sin}^{2} ( w ) + {sin}^{4} ( w ) ) )}} , & ( 35 ) \\ ω ( β ) = {\int }_{- \frac{π}{2}}^{\frac{π}{2}} \frac{ⅆ w}{\sqrt{β ( 1 + {sin}^{2} ( w ) - β ( 1 + {sin}^{2} ( w ) + {sin}^{4} ( w ) ) )}} , \\ where & ( 36 ) \\ \tilde{ϕ} = \sqrt{\frac{2}{3}} \frac{ϕ}{r} , \\ χ = \sqrt{\frac{3}{λ}} \frac{{μ}^{2}}{2} x \\ and \\ β = \frac{2}{3} \frac{λ {r}^{2}}{{μ}^{2}} . & ( {36}^{′} )\end{matrix}$$

It follows from the non-negativity of the expression under the square root in (36) that 0<β<⅔. The plot of function (35) for χ(\tilde{φ}, 0.075), χ(\tilde{φ},0.662), both corresponding to ω(β)=10, is presented on FIG. 9.

[image]

We note that solution (35) to equation (34) corresponds to kinks passing from one potential well to another. But function (35) is qualitatively different from (28″). First, the set of solutions to (34) has two branches: for ω≈5.76, (34) has two solutions; for ω≦5.76 (β≈0.407), equation (34) has only one solution; for ω≦5.76, there are no solutions. Point ω≈5.76, β≈0.407 is the point of bifurcation of system (34). For L→∞, the left branch of the solution approaches the trivial solution, φ=±μ/\sqrt{λ}, and the right branch approaches the following solution to equation

$$ϕ = \pm \frac{μ}{\sqrt{λ}} ,$$

$$χ ( \tilde{ϕ} , β ) = - \frac{\sqrt{3}}{2 \sqrt{2}} [ atanh ( \frac{1}{\sqrt{3}} \frac{2 \tilde{ϕ} + 1}{2 {\tilde{ϕ}}^{2} + 1} ) + atanh ( \frac{1}{\sqrt{3}} \frac{2 \tilde{ϕ} - 1}{2 {\tilde{ϕ}}^{2} + 1} ) ] ,$$

corresponding to the boundary conditions at infinity.

Let's consider motion equations for the potential U₃(φ) with periodic boundary conditions (29):

$$\frac{{ⅆ}^{2} ϕ}{ⅆ {x}^{2}} = v ϕ - {μ}^{2} {ϕ}^{3} + λ {ϕ}^{5} . \qquad ( 37 )$$

Besides the quantum field theory, equation (37) is of particular interest as it can be interpreted as a Schrödinger equation for a gas of particles moving in the self-adjusted potential U_{eff}(φ) (Gross-Pitaevskii equation). Indeed, equation (37) appears to be a Schrödinger equation corresponding to the Hamiltonian:

$$H ( ϕ ) = - \frac{{ℏ}^{2}}{2 {m}_{eff}} Δ + {U}_{eff} ( ϕ ) ,$$

with effective potential

$${U}_{eff} ( ϕ ) = - \frac{{μ}^{2} {ℏ}^{2}}{2 {m}_{eff}} n ( Ψ ) + \frac{{λℏ}^{2}}{2 {m}_{eff}} {n ( Ψ )}^{3} , \\ where$$

$$Ψ ( x , t ) = exp ( - iE \frac{t}{h} ) ϕ ( x )$$

is the wave function, n(Ψ)=|Ψ|² is the probability density, m_{eff} is the effective mass of a particle, h is Plank's constant and E is the eigenvalue. Setting

$$v = - \frac{2 {Em}_{eff}}{{h}^{2}} ,$$

(37) becomes Schrödinger equation:

$$- \frac{{ℏ}^{2}}{2 {m}_{eff}} Δ ϕ - \frac{{μ}^{2} {ℏ}^{2}}{2 {m}_{eff}} {ϕ}^{3} + \frac{λ {ℏ}^{2}}{2 {m}_{eff}} {ϕ}^{5} = E ϕ .$$

Applying procedures (31-33) to equation (37) yields:

$$\begin{matrix}χ ( ϕ , β , η ) = {\int }_{\frac{ϕ}{r}}^{1} \frac{ⅆ v}{\sqrt{( 1 - {v}^{2} ) ( β ( 1 + {v}^{2} - β ( 1 + {v}^{2} + {v}^{4} ) ) - η )}} \\ and & ( 38 ) \\ ω ( β , η , {v}_{0} ) = {\int }_{arcsin ( {v}_{0} )}^{\frac{π}{2}} \frac{ⅆ w}{\sqrt{β ( 1 + {sin}^{2} ( w ) - β ( 1 + {sin}^{2} ( w ) + sin ( w ) ) ) - η}} \\ where \\ χ = \sqrt{\frac{3}{π}} \frac{{μ}^{2}}{2} x , β = \frac{2}{3} \frac{λ {r}^{2}}{{μ}^{2}} . & ( 39 )\end{matrix}$$

The upper boundary of integration in (38-39) is determined by the condition that φ attains its maximum r at x=0. To define v₀, we note that the periodic boundary condition requires a minimum of φ(x) at points x=±L, so that v₀=φ(±L)/r. These conditions are met when the expression under the square root in (38) is equal to 0. There are two types (subsets) of solutions (38) satisfying these conditions. The first type is defined by the condition:
v₀=−1, when φ(L)=−r; (40)
and the second type is defined by:
β(1+v₀²−β(1+v₀²+v₀⁴))−η=0. (41)

Analyzing the first solution subset and substituting (40) into (39), we obtain the following equation for the first type of periodic solution to (37):

$$ω ( β , η ) = {\int }_{- \frac{π}{2}}^{\frac{π}{2}} \frac{ⅆ w}{\sqrt{β ( 1 + {sin}^{2} ( w ) - β ( 1 + {sin}^{2} ( w ) + {sin}^{4} ( w ) ) ) - η}} . \qquad ( 42 )$$

The plot of the function ω(β, 0.24) is presented on FIG. 11.

[image]

It easy to see from FIG. 11 that at point β=β_{b}, ω=ω_{b}, bifurcation takes place, and for ω>ω_{b} there are two solutions to (37) of the first type for every given c. The non-negativity of the expression under the square root in integral (39) gives the following restriction on β:

$$\frac{1}{2} - \frac{1}{2} \sqrt{1 - 4 η} < β < \frac{1}{3} + \frac{1}{3} \sqrt{1 - 3 η} .$$

For

$$β -> \frac{1}{2} - \frac{1}{2} \sqrt{1 - 4 η} ,$$

the asymptotical behavior of ω(β,η) is given by

$${ω}_{left} ( β , η ) = - \frac{1}{\sqrt{η}} ln ( β - {β}^{2} - η ) ,$$

and for

$$β -> \frac{1}{3} + \frac{1}{3} \sqrt{1 - 3 η} ,$$

it is given by

$${ω}_{right} ( β , η ) = - \frac{1}{\sqrt{3 β - {β}^{2}}} ln ( 2 β - 3 {β}^{2} - η ) .$$

For η→¼, integral (42) can be written as the following approximate expression:

$$ω ( β , n ) = - 2 ln ( \begin{matrix}( 1 - {z}^{ 2} ) \\ ( \frac{1}{ 4} - η - z - 3 ( \frac{1}{ 4} - η ) {z}^{ 2} )\end{matrix} ) - 6 ln ( \frac{1}{ 4} - η ) , \\ where \\ z = \frac{4 β - 2}{1 - 4 η} \qquad ( 43 )$$

As one can see from FIG. 11 and formula (43), for η→η₀=¼, the branches of the first solution subset come infinitely close, while point of bifurcation ω=ω_{b} approaches infinity. It is important to note that no method of perturbation theory is able to detect this effective “collapse” of branches of the first solution subset of (37). But from the mechanics of the “collapse” described above, it follows that for any large but finite L, such η≈¼ exists so that solutions to (31) with periodic boundary conditions (25) will be significantly different from solutions to (31) with boundary conditions at infinity.

It is interesting to note that, in interpreting (37) as a Gross-Pitaevskii equation, parameter η=¼ corresponds to the energy of the ground state. It is reasonable to speculate that this condition can help to establish some kind of quantization procedure without using free parameters and avoid any appearance of singularities in the energy integral, but these speculations are beyond the scope of this paper. In order to produce reasonable results, the condition of “collapsing” and the method of alternative parameters must be applied to more realistic physical models (i.e., the 3-dimensional model of the Jang-Mills field, electro-gravity, etc.).

The second subset of solutions to (31) is defined by the condition

$${v}_{0} = \sqrt{\frac{1 - β - \sqrt{2 β - 3 {β}^{2} + 1 - 4 η}}{2 β}} . \qquad ( 44 )$$

Condition (44) was substituted into formulas (38) and (39), and the results of this calculations are presented on FIGS. 12 and 13.

$$η = \frac{1}{4}$$

[image]

The plots of functions (38) for the second solution subset, corresponding to condition (44), are presented on FIG. 14.

$$η -> \frac{1}{4} ,$$

[image]

It is easy to see that for

$$β \to \frac{1}{2} and η \to \frac{1}{4} + ,$$

solutions to (37) calculated by formula (38) after substitution of (44) converge with the solutions to (37) with boundary conditions at infinity, and correspond to the quantum field theory model with two topological sectors. Indeed,

$$η = \frac{1}{4}$$

corresponds to the triple well potential U₃(φ, a, b, c), presented on FIG. 15.

[image]

The second subset of solutions to (37) defined by condition (44) corresponds to the passing of the system from the right well to the central well in the triple well model. But condition (44) for

$$η = \frac{1}{4}$$

has a unique solution:

$$β = \frac{1}{2} .$$

Indeed, after substitution of

$$η = \frac{1}{4}$$

into (44), the condition of non-negativity of the expression under the square root becomes
1−β−\sqrt{2β−3β²}>0.

$$η -> {η}_{0} = \frac{1}{4} ,$$

This inequality has a unique solution

$$β = \frac{1}{2} .$$

Substituting

$$η = \frac{1}{4} , β = \frac{1}{2}$$

into (38), we obtain the solution to (37), subjected to boundary conditions at infinity:

$$\begin{matrix}χ ( v , β , η ) = {\int }_{{v}_{0}}^{1} \\ \frac{ⅆ v}{ \sqrt{( 1 - {v}^{2} ) ( \frac{1}{2} ( 1 + {v}^{2} - \frac{1}{2} ( 1 + {v}^{2} + {v}^{4} ) ) - \frac{1}{4} )}} .\end{matrix} \qquad ( 45 )$$

But for

$$β = \frac{1}{2} , η = \frac{1}{4} , {v}_{0} = 0 ,$$

integral (45) is singular, meaning that equation (37) has no solution.

Hence

$$η = \frac{1}{4}$$

is a point of singularity for equation (37) with periodic boundary conditions. Indeed, for

$$η = \frac{1}{4} ,$$

equation (37), with periodic boundary conditions, has no solution for any finite L, while (37) does have a solution with boundary conditions at infinity. When η approaches ¼ from above, periodic solutions to (37) for L going to infinity are approaching the limit, corresponding to the solution of (37) with boundary conditions at infinity. The first subset of periodic solutions to (37), for period L approaching infinity, and η approaching ¼ from below, do not approach solutions to (37) with boundary conditions at infinity, while the second subset of periodic solutions to (37) does. The first subset of the solutions to (37) corresponds to the configuration antikink1-kink1-kink2-antikink2 (FIG. 15), which in turn corresponds to the passing of the system from the right well to the left well through the central well. That configuration contradicts the concept of a topological sector altogether.

### CONCLUSIONS

The method of alternative parameters presented above appears to be not only a very powerful tool for solving nonlinear boundary value problems, but also is a very effective method for classifying and theoretically analyzing such nonlinear boundary value problems.

Ceramic electrode problem (1) can be analysed by reduction to the following symplified mathematical modele:
Δu(x)=−Dθ(u(x)) on G,
u(x)=0, xε∂G, (46)

,where σ(T)=σ₀exp(−T_{c}(T(x)+T_{w}), λ(T)=λ₀=const, u(x)=T(x)T_{c}, E—electric field,

$$\begin{matrix}θ ( u ( x ) ) = \frac{{E}^{2} {σ}_{0}}{{λ}_{0} L} exp ( - {T}_{c} / ( T ( x ) + {T}_{w} ) ) \\ = \frac{{E}^{2} {σ}_{0}}{{λ}_{0} L} exp ( - 1 / ( u ( x ) + {u}_{w} ) ) ,\end{matrix}$$

$${u}_{w} = {T}_{w} / {T}_{c}$$

It follows from (10), that for problem (46) to have a point of bifurcation and corresponding multiple solutions, it is necessary that the following condition be achieved
θ(u)−θ′(u)u=0 (47)

at some point in the area of consideration. It is obvious that there exists T_{critical}, so that for T_{w}>T_{critcal} condition (47) cannot be fulfilled anywhere in the area of consideration, the solution is unique and catastrophical transition from one solution to another is impossible. Considering that the metal frame of the electrode cooled by water cannot have a temperature higher than 100 C, the desired effect can be achieved by designing the ceramic electrode so that heat is collected by the metal frame of the ceramic body of the electrode, while the electric current is collected from the area of consideration by another metal frame or grid inside the body of the electrode, resulting in a temperature in the grid that is higher than the critical temperature described above, and the area where Joule heating is taking place has a unique solution of corresponding thermal conductivity with a Joule heating mathematical

$$η \approx \frac{1}{4}$$

model. The corresponding design is presented on FIG. 16.

Additional applications of these methods to the quantum field theory demonstrated that the existence of solutions to triple well potential scalar field models is characteristic for boundary conditions at infinity only, while scalar field model (37), defined on a circle of final radius, cannot employ triple well potential corresponding to /nu=¼, as these equations do not have a solution. The only way to overcome this difficulty is to modify triple well potential U₃(φ)=U(φ,−η,−μ²,μ). But while modifying triple well potential U₃(φ), one should keep in mind that infinitely small changes in the parameters of this potential can cause significant divergence in the solutions.

Whether the conclusions presented here are true for more realistic three-dimensional quantum field theory models remains to be seen, but it is clear that the universal assumption that our Universe is big enough to apply boundary conditions at infinity for quantum field theory models requires additional consideration. Generally speaking, to model the Universe by the scalar field, one may find it necessary to take into account the global structure of the Universe.

Thus, taking these conclusions into account, it becomes obvious from Equations 42, 44 and 45 that particles and field correspond to different solutions of the same quantum field equation and appear to be metastable solutions of the corresponding quantum field equation considered above. It is obvious from the principle of dynamic equilibrium that the existence in the same area of space of a gas of particles in coherent state (for instance, bose condensate), together with a gas of corresponding photons, can provoke a spontaneous transition of a gas of particles corresponding to the contracted solution into the field of photons, thus constituting a power generator.

Bibliography

1. Pohozaev, About the Eigenfunctions of the Equation Δu+λf(u)=0. Dokladi Akademii Nauk SSSR (1965), pp. 1408-1411.
2 D. Gilbarg, N. S. Trudinger, Elliptic Partial Differential Equations of Secondary Order. Springer Verlag, Berlin (1989).
2. H. Brezis and L. Nirenberg, Positive Solutions of Non-Linear Elliptic Equations, Involving Critical Sobolev Exponents. Commum. Pure Appl. Math, 36 (1983), pp. 437-477.
3. R. Rajaraman, Solitons and Instantons, An Introduction to Solitons and Instantons in Quantum Field Theory. North-Holland Publishing Co. (1987)
4. R. K Dodd, J. C. Eilbeck, J D. Gibbon, and H. C. Morris, Solitons and Nonlinear Wave Equations. Academic Press, London (1982).
5. A. Poliakov, Gauge Fields and Strings (Contemporary Concepts in Physics, Vol. 3). Taylor and Francis (1987).
6. Rudiger Seydel, Practical Bifurcation and Stability Analysis, From Equilibrium to Chaos. Springer-Verlag, New York (2nd ed. 1994).
7. David H.Sattinger, Topics in Stability and Bifurcation Theory, Lecture Notes in Mathematics. Springer-Verlag, Berlin, Heidelberg, New York (1973), p. 309. bibitem

1. A configuration of ceramic electrodes, where metal frame collecting heat is separated from the metal frame collecting current so that the area of consideration where Joule heating is significant has a unique solution to a corresponding mathematical model presented above, as the temperature of the current collecting metal frame exceeds critical value, thus preventing contraction phenomena in ceramic electrodes.

2. A power generator comprised of a resonance chamber consisting of two mirrors and containing a gas of particles that are subjected to a corresponding radiation so that the metastable state of primary energy constituting these particles is provoked to be transformed into radiation, collected by a screen transforming this radiation into alternative energies, such as heat.

3. Device 2 where said gas of particles appears to be a bose condensate making particles of this gas to be coherent to each other.

4. A method of determining safe parameters of any critical phenomena determined by the existence of several solutions to the corresponding equation and catastrophic movement of the system from one solution to another.

5. The mathematical considerations presented in our provisional application A/001 PROV can provide a range of parameters allowing for the safe functioning of dynamic systems described by nonlinear partial differential equations, including nano-elements of p-n boundaries in microchips such as are utilized in CPUs.
